(19) United States
(12) Patent Application Publication
(10) Pub. No.: US 2025/0122068 A1
(43) Pub. Date: Apr. 17, 2025

(54) Treatment Head for Treating Kegs

(71) Applicant: KHS GmbH, Dortmund (DE)

(72) Inventors: Volker Damerow, Uelversheim (DE); Sebastian Eckes, Langenlonsheim (DE); Maximilian Weindorf, Münsterappel (DE); Christian Pedersen, Kriftel (DE); Manfred Wahl, Oberwiesen (DE); Andreas Weber, Bad Sobernheim (DE); Olaf Muszinski, Bad Soden (DE)

(21) Appl. No.: 18/580,683

(22) PCT Filed: Aug. 30, 2022
(86) PCT No.: PCT/EP2022/073989

§ 371 Date: Jan. 19, 2024

(30) Foreign Application Priority Data
Aug. 31, 2021 (DE) 10 2021 122 428.4

(51) Int. Cl. B67C 3/34; B67C 3/28

(52) U.S. Cl. CPC B67C 3/34; B67C 3/28

(57) ABSTRACT

The invention relates to a treatment head (1) for treating kegs (3), each of which is equipped with at least one keg fitting (2). The treatment head (1) has a treatment head housing (4), as well as at least one plunger (5), which is held in the treatment head housing (4) so as to be displaceable in the axial direction of a treatment head axis (BA), for opening the keg fitting (2) of the keg (3) which is to be treated and is disposed in a sealing position on the treatment head (1). At least one fluid space (6) as well as flow paths or conduits (SK1, SK2) which communicate controllably with the fluid space (6) are formed in the treatment head (1). The flow paths or conduits (SK1, SK2) can be connected to the interior (3.1) of the keg (3) to be treated when the keg fitting (2) is open. The treatment head (1) also has at least one first controllable media valve (7) which is associated with the fluid space (6), is connected to a filling product feed (8) and is designed as a product valve for controlled feeding of a filling product, in particular a beverage, into the interior (3.1) of the keg (3) to be treated, as well as at least one second controllable media valve (12) which acts as a return valve. The invention is characterised in particular in that at least the first media valve (7) which acts as a product valve has a multiple sealing arrangement (9) for multiple sealing of the filling product feed (8) with respect to the fluid space (6). By means of the multiple sealing arrangement (9) at least one safety or leakage space (10) is formed which in at least one first closed valve position (V1) of the first media valve (7) forms a separate intermediate space between the fluid space (6) and the filling product feed (8).

### RELATED APPLICATIONS

This application is a national phase under 35 USC 371 of International Application No. PCT/EP2022/073989, filed on Aug. 30, 2022, which claims the benefit of the filing date of German Application No. 10 2021 122 428.4, filed on Aug. 31, 2021, the contents of all of which are incorporated herein by reference in their entireties.

### FIELD OF INVENTION

The present invention relates to the treatment of kegs.

### BACKGROUND

Reusable barrels, also referred to as “kegs,” “keg barrels,” or “keg containers,” are widely known in the beverage industry. Such kegs are used principally when beverages or other fluid products are handled and dispensed as filling products in large quantities, in particular in quantities greater than five liters. In the catering industry, it has frequently proven particularly advantageous to handle beverages in kegs rather than in bottles or cans.

Among the advantages of a keg is that it comes with a valve that can be used when cleaning or filing the keg as well as for drawing or “tapping” filling product out of the keg during use. This valve is often called a “fitting” or a “keg fitting.”

Reusable kegs, with their respective fittings, are typically run through several usage cycles. In each such cycle, after having been drained of its filling product, a keg is returned to a filling plant to be cleaned before being refilled. In the beverage industry, this is typically carried out automatically and on an industrial scale within large plants and using fully-automated machines or systems having one or more stations for the cleaning or filling of the kegs. Such machines or systems can also be designated as “treatment devices” or “treatment systems.”

With such treatment systems for kegs it is usual to move the kegs through the system upside down, i.e., with the fitting facing downwards, to run the keg through the individual treatment stations in this alignment, and to subject the keg to various treatment media. The keg's fitting is used to provide a connection to enable treatment media to pass into or out of the keg.

Treatment of a keg thus includes establishing contact between the downwardly oriented fitting and a treatment head at the treatment station. This includes aligning the fitting and the treatment head and connecting them to each other to form a seal between the treatment head and the fitting.

With the treatment devices or treatment systems described heretofore, the kegs are, as a rule, treated in large numbers and with a high throughput. In this situation, for the cleaning and filling process, the kegs run through different cleaning and filling stations that are spatially separated from each other but that are fixed in their positions, wherein a predetermined cleaning and filling process runs in more or less the same manner for all the kegs that are to be treated.

There has been a trend towards smaller independent breweries and beverage filling plants, such as “craft beer” brewers. This has created a need for a wider variation of cleaning-and-filling processes. Accordingly, a need has arisen for treatment systems that are more flexible.

### SUMMARY

An object of the invention is to provide a multifunctional treatment head for the treatment of kegs in a way that reliably avoids mixing of serially-used treatment media and that does so in a particularly hygienic and problem-free manner so as to reliably reduce product loss.

The invention concerns a treatment head for treating kegs, each of which is equipped with at least one keg fitting. The invention further relates to a cleaning-and-filling module for interior cleaning and filling of kegs, each of which is equipped with at least one keg fitting, in a treatment system with a plurality of such cleaning-and-filling modules, as well as to a method for the interior cleaning and filling of kegs, each of which is equipped with at least one keg fitting, by means of such a cleaning-and-filling module.

The present invention provides a treatment head for the treatment of kegs, each equipped with at least one keg fitting. The treatment head comprises at least one treatment-head housing, as well as at least one plunger which is held in the treatment-head housing so as to be displaceable in the axial direction of a treatment head axis, for opening the keg fitting of the keg which is to be treated and is arranged in a sealing position on the treatment head. Formed in the treatment head are at least one fluid space, as well as flow paths and conduits which communicate in a controllable manner with the fluid space. With the keg fitting open, the flow paths or conduits can be connected to an interior of the keg which is to be treated. The treatment head further comprises at least one first controllable media valve, which is associated with the fluid space and is connected to a filling product feed, and, as a product valve, is configured to provide a controlled feed of a filling product, in particular of a beverage, into the interior of the keg which is to be treated. The treatment head further comprises at least one second controllable media valve, which acts as a return valve. According to one particular aspect of the invention, at least the first media valve, acting as a product valve, comprises a multiple sealing arrangement for multiple sealing of the filling product feed with respect to the fluid space, wherein, by means of the multiple sealing arrangement, at least one safety or leakage space is formed, which in at least one first closed valve position of the first media valve forms a separate intermediate space between the fluid space and the filling product feed.

The designation of kegs, which in the present situation can also be designated as keg barrels or keg containers, comprises in the meaning of the invention both the cleaning and also the filling of the kegs, wherein the treatment head is configured in this case as a multifunctional treatment head, which is designed in particular for the cleaning and filling in each case as a keg equipped with a keg fitting. The treatment head can in this case therefore also be designated as a combined filling and cleaning head, or as a combi-head. The terms multifunction head or multi-head can also be used as synonyms for this treatment head.

A “filling product” in the meaning of the present invention can be, for example, a beverage, in particular a beverage containing carbon dioxide. For example, the filling product can be beer, a beer mixed beverage, or a carbonated soft drink.

The treatment head in this situation is assigned to a specified treatment station, such that the treatment station which comprises the treatment head is also a multifunctional treatment station, namely a cleaning and filling station in which the keg which is to be treated is both cleaned as well as filled. By analogy with the designations in relation to the treatment head, it is therefore also possible for the treatment station comprising the treatment head to be designated as a combined filling and cleaning station or combi-station or as a multifunction station or multi-station.

The “cleaning” carried out by means of the treatment head relates in this situation essentially to the cleaning of the interior, namely the inner space of the keg, and is also to be understood as an interior cleaning of the keg. This interior cleaning is carried out in a cleaning procedure or cleaning process, with at least one cleaning step, by means of at least one cleaning medium or cleaning means, wherein a “cleaning medium” or “cleaning means” comprises both fluid and gaseous or vaporous media or fluids, which, in particular, can be applied at different temperatures, such as warm, hot, or cold. As “cleaning media” or “cleaning means,” which in the present case can also be designated as treatment media, there come into consideration all media which are used in the foodstuffs industry sector, in particular the beverage industry, usually in connection with media used in a cleaning, which are commonly known to the person skilled in the art. The terms “cleaning media” or “cleaning means” can comprise in particular also disinfection media and/or, for example, water, air, nitrogen, or carbon dioxide gas, which are used in interior cleaning for the cleaning, flushing, or for the drying or blowing out of the kegs. The cleaning preferably comprises several different cleaning steps with different cleaning media or cleaning means, wherein the several cleaning steps can be carried out, for example, sequentially or following one another. The cleaning can also include in this case a “flushing”, wherein, for this purpose, use can be made of a treatment medium which is also designated as a flushing medium.

Due to the multiple sealing arrangement in at least the media valve, configured as a product valve, the filling product feed is sealed several times over in relation to the fluid space formed in the treatment head, in the treatment-head housing. As a result, the cleaning media are always and particularly reliably separated from the filling product. In the first closed valve setting of the first media valve, which can also be understood as the cleaning or flushing setting, in this situation the safety or leakage space formed by the multiple sealing arrangement provides a separate space, which, as an intermediate space, separates the fluid space and the filling product feed completely and in a sealed manner from one another, or separates or isolates them from one another. The safety or leakage space can therefore also be designated as an intermediate space separating the fluid space and the space of the filling product feed, or as a separation space or lock-type space, which, in particular in the first closed valve setting of the media valve, forms an isolation space.

Particularly advantageously, the safety or leakage space can be opened to the outside by means of a flushing device, in particular by a specially provided valve, which can be designated, for example, as a satellite valve, and/or by means of a specially provided controlled outlet, in order to flush this safety or leakage space separately, or to be able to drain off media.

Very particular advantages are derived with the treatment head according to the invention, since both the interior cleaning as well as the filling of a respective keg—and in this situation, in particular all the steps required for the cleaning and filling processes—can be carried out in a particularly reliable manner with one and the same treatment head, without thereby incurring the risk of the filling product unintentionally coming in contact, in one of the steps during the cleaning and filling process, with cleaning media or cleaning means, or even being mixed with them.

Further advantages derive from the fact that the keg fitting of the keg which is to be treated is coupled to the treatment head during the entire cleaning and filling process, and is connected to this in particular in a sealing manner. As a result, the keg which is to be treated advantageously remains in one and the same treatment station during the entire cleaning and filling process. The keg which is to be treated is therefore assigned to a single treatment head for the entire cleaning and filling process, as well as, integrally with this, to a single treatment station, and remains stationary in this treatment station over the entire duration of the treatment.

Multiple coupling and decoupling of the keg fitting to and from different treatment heads during the cleaning and filling process no longer takes place in this situation, as a result of which, advantageously, the keg fittings of the kegs are protected and are therefore subject to less wear. This also advantageously leads to time saving, wherein not only can time be saved with regard to repeated coupling and decoupling of the keg fitting to the treatment head, but, in addition, the transport time can also be saved which in conventional systems is necessary for predetermined transport steps in order to transport the keg from one treatment station to the next.

By means of the multiple sealing arrangement provided according to the invention, and the safety and leakage space formed by this, effective prevention is provided of an undesirable coming in contact or mixing of filling product and cleaning medium, as well as, for example, filling product losses and complaints from the trade, and, as a result, costs are reduced or saved for the filling plant. In addition, a possible impairment in taste or hygiene of the filling product filled into the keg can be effectively counteracted, such that, here too, the risk of quality losses or even of a potential effect hazardous to the health of the consumer can be avoided.

According to one preferred embodiment variant, provision is further made with the multiple sealing arrangement for a flushing device, in particular a flushing valve, for flushing the safety or leakage space. As a result, the safety or leakage space can be flushed, wherein, further, a controlled discharge is possible by way of the safety or leakage space. By this means, the permanent secure separation of the cleaning media from the filling product is additionally supported. In particular, it can be ensured in an even better manner that all the cleaning residues or cleaning means which may have penetrated into the safety or leakage space can be flushed out and removed before the corresponding steps for the actual filling process are carried out. The entire filling product path, namely the path which the filling product passes along during the filling of the keg, starting from the filling product feed and through the fluid space with the communicating flow paths or conduits, can therefore be kept clean and, in particular, free of undesirable cleaning media or residues from the keg. Advantageously, the preferred flushing device has the effect in particular of providing support and additional reinforcement for the effect already mentioned of the effective avoidance of filling product losses and/or risks for the end user.

Further advantageously, due to the presence of the safety or leakage space, there is also the possibility of checking the tightness of seals, wherein, for example, possible leaks or sealing defects in seals can be detected by optical monitoring by an operator or by suitable sensors.

The multiple sealing arrangement of the first media valve is preferably formed by a double seat or double sealing leakage valve. In the meaning of the present invention, the double seat valve or double sealing leakage valve can also be designated as a double seat valve or double sealing valve.

Advantages are derived in that at least two flow paths or conduits are formed in the treatment head, wherein the first flow path or conduit can be subjected to the filling product in a controlled manner, and the interior of the keg can be filled with the filling product via the first flow path or conduit, and wherein the second flow path or conduit serves to provide the controllable removal of at least one treatment medium out of the interior of the keg and/or for the controllable feed of at least one treatment medium into the interior of the keg, and extends at least partially through the plunger. With special embodiment variants it is possible, if special types of kegs are being treated, such as kegs with bags, for a switch from the first flow path to the second flow path to be carried out, wherein, for this purpose in particular, a special plunger is used in conjunction with a fitting which is suitable for this function.

According to one particularly preferred embodiment variant, the second controllable media valve serving as a return valve also comprises a multiple sealing arrangement, wherein the multiple sealing arrangement of the return valve is preferably formed by a double seat valve or double sealing leakage valve. For example, in this way a flow switch can be reliably carried out during the cleaning.

According to one particularly preferred embodiment variant, two double seat valves or double sealing leakage valves are provided at the first controllable media valve. As an alternative or in addition to this, according to a likewise particularly preferred embodiment variant, a double seat valve or double sealing leakage valve is arranged in the region of the filling product feed connected to the first controllable media valve. The presence of the at least two double seat valves or double sealing leakage valves in the region of the product valve and the filling product feed allows, for example, for simple switching between different filling products from keg to keg, and therefore, for example, makes a product change easier, as a result of which a multiproduct filling is also simplified.

The media valves each comprise a valve-housing section, by means of which the media valves connect to a transition section or valve transition section of the treatment-head housing. The respective valve-housing sections can be configured, for example, as integral parts of the treatment-head housing, and as being of one piece with it. A cavity space is formed in each case in the interior of the valve-housing sections, which is connected together to the fluid space, and at least in some sections is actually a part of the fluid space.

For particular preference, the first media valve comprises a product valve axis, and the second media valve comprises a return valve axis. Particular advantages are derived from the fact that the first media valve and the second media valve are arranged relative to one another in such a way that the product valve axis and the return valve axis enclose an angle of less than 180°, in particular an angle of less than 90°. For particular preference, the media valves are arranged relative to one another in such a way that the product valve axis and the return valve axis enclose an angle in the range from around 20° to 70°, for particular preference in a range from 25° to 50°, and, for example, an angle of around 300 or around 35°. By way of this arrangement, the two media valves are arranged essentially “next to one another” at the treatment head, and do not lie opposite one another in relation to the treatment head axis. As a result, on the one hand spatial advantages are derived for the connection of media lines leading to and from the media valves, as well as fundamentally improved access to them. Moreover, as a result the treatment media are particularly advantageously guided and conveyed, such that the flow of treatment media takes place in an optimum manner due to this arrangement of the media valves.

According to one advantageous variant, the first controllable media valve, acting as a product valve, comprises a valve seat, and a valve body which can be moved in the direction of the product valve axis, with a sealing surface, wherein an actuator drive is provided for the movement of the valve body along the product valve axis. The valve body can therefore in this situation also be understood as an actuator drive plunger. In this situation it is possible for the actuator drive or valve drive to take effect on the valve body in the axial direction of the product valve axis, and the actuator drive therefore takes effect in an axis with the valve body. As an alternative, the actuator drive or valve drive can also be configured in such a way that a drive force or drive direction taking effect on the valve body is not oriented in the axial direction of the product valve axis, but at an angle to the product valve axis.

For particular preference, in this situation, in the first closed valve setting, the sealing surface of the valve body lies at least in sections in a sealing position against the valve seat of the first media valve.

According to a particularly preferred embodiment variant of the invention, the multiple sealing arrangement is configured as a double-seat valve with separately switchable valve seats, wherein separate actuator drives or valve drives are also provided.

The valve body can preferably also be moved by an actuation movement in the direction of the product valve axis into at least one second valve setting, wherein, in the second valve setting, the fluid space is fluidly connected to the safety or leakage space, and the filling product feed is sealed against the safety or leakage space which is in fluid connection with the fluid space. In this situation, the second valve setting defines an intermediate or flushing setting of the first media valve. In this situation, the fluid space connected to the safety or leakage space is to be opened to the outside, for example by way of the fluid space connected to the safety or leakage space and the corresponding associated outlet or discharge opening to the outside.

The valve body can also be moved by an adjustment movement in the direction of the product valve axis into at least one third valve setting, wherein, in the third valve setting, the fluid space is fluidly connected to the safety or leakage space and with the filling product feed. In this situation, the third valve setting defines an opening setting or filling setting of the first media valve.

According to a particularly preferred embodiment variant, the valve body comprises a projection which projects in the axial direction of the product valve axis over the sealing surface, wherein, in order to reduce a dead space, in at least the first valve setting, the projection extends at least in sections into the interior of the fluid space. According to another likewise preferred variant, the valve seat can be configured as pivoting or folding. As an alternative or in addition, provision can also be made for the valve body, or at least a front region of the valve body or a valve body tip, to exhibit an asymmetrical geometry or a free form. Moreover, the valve body can be lengthened in its front region, and therefore serve as a lengthened valve plunger, wherein the lengthening can, for example, be mirror-symmetrical.

For particular preference, the valve body extends in its length along the product valve axis, wherein preferably an axis of the valve body is located coaxially to the product valve axis. In particularly preferred embodiments, therefore, the valve seat, the valve body, the valve-housing section surrounding the product valve axis, and, additionally, the actuator drive are aligned coaxially. As an alternative, however, the valve seat and/or the actuator drive can be arranged axially offset or obliquely or at an angle.

For example, in the region of the fluid space an elastic element or an elastic section can be provided, in order to make easier the resetting or withdrawal of the valve body against the non-compressible fluid.

Preferably, the fluid space exhibits, in the region of the first and/or second media valve, a cross-section shape which deviates from a circular shape, and in particular is oval. The “cross-section shape of the fluid space” relates in this situation to the shape of a cross-section with a cut direction or cut plane parallel or essentially parallel to the treatment head axis, namely a cross-section through the fluid space running in the direction of the treatment head axis, and specifically cut at a point or in a region at the transition of the fluid space to the valve seat, i.e. at a point or in a region where the hollow space in the valve-housing section, in particular a valve space of the first media valve, and in particular the valve space conveying the filling product, opens into the fluid space.

It is self-explanatory that a cross-section shape “which deviates from a circular shape” covers the most widely differing possible shapes, and among them in particular asymmetrical shapes or a “free form”.

The multiple sealing arrangement of the first and/or second media valve advantageously comprises in each case at least one first sealing element and a second sealing element. At least one of these two sealing elements provided exhibits for particular preference a shape which deviates from circular, in particular an oval shape or an asymmetric shape or a free form. The sealing element or sealing elements are preferably arranged and configured in such a way that it/they form a seal in the fluid space in the region of the first and/or second media valve. In the variant described above, with a “free form” seal, this seal can be configured in a very particular embodiment variant, for example almost oval and multiple cambered, in particular cambered in several planes. The type and dimensions of the multiple cambering are, for example, optimized such as to minimize the dead space. The optimization of the “free form” is effected in this case, for example, also as a dependency of the function and requirements of the seal, as well as a dependency of the function of the media valve and/or of the manufacturing possibilities.

In a further preferred embodiment variant, as an alternative or addition, it is possible in particular for the first media valve, configured as a double sealing valve, to be provided or equipped with a respective rotational securing element. This advantageously makes it possible for a valve body tip to exhibit, for example in the region of the projection projecting over the sealing surface in the axial direction of the product valve axis, an asymmetric shape, or a free form, as a result of which the dead space can be further minimized.

In the first instance, features and advantages in relation to the multiple sealing arrangement are described in greater detail only in connection with the first media valve, acting as a product valve. The features and advantages do of course also relate by analogy to a multiple sealing arrangement provided in the second media valve.

Preferably, the first and/or second media valve are arranged obliquely in the treatment head, namely in such a way that, in this situation, the product valve axis and/or the return valve axis enclose in each case an acute or essentially acute angle with the treatment head axis. With the keg to be treated in the “upside down” position, in the operational state with the keg coupled up, the treatment head is arranged underneath the keg, and in this situation essentially coincides with a keg main axis or with a perpendicular axis of the keg, such that, in the preferred embodiment variant described, the first and/or second media valve project obliquely downwards in relation to the treatment head axis and the keg main axis. According to preferred embodiment forms, the product valve axis and/or the return valve axis enclose an angle with the treatment head axis in a range from about 25° to 45°, for particular preference in a range from about 30° to 40°, and for particular preference of some 35°. This makes the connection of media lines and improves basic accessibility. This also leads to an improved flow behavior of the media in and through the treatment head.

Advantages are further derived from the fact that in the treatment-head housing a guide surface is formed, and a deflection of the filling product, wherein the guide surface extends at least in sections in the fluid space and/or in sections delimits the fluid space. In addition to this, it is also possible, for example, for an efficient deflection of the filling product to take place upwards towards the keg. The guide surface is preferably formed by a free-form surface directed upwards.

With the treatment head described, as specified heretofore and particularly advantageously, an effective and reliable deflection of the product flow in the direction onto the ring conduit of the keg is possible, and in particular with the simultaneous avoidance of turbulent disturbances in the flow behavior.

The treatment head described advantageously further comprises a control and/or monitoring unit, which is in communicating connection with the media valves, which in particular controls and/or monitors the media valves. In particular, the control and/or monitoring unit also controls and/or monitors the setting movements of the valve body, as well as the respective valve settings of the media valves. The control and/or monitoring unit is further configured such as to control and monitor the individual steps of the cleaning and filling processes, and/or, in order to carry out the controlling and regulating and monitoring of the cleaning and filling processes, to communicate with at least one further controlling and/or regulating system which is preferably additionally provided.

With the treatment head described, preferably one or more probe(s) and/or at least one or more sensor element(s) are also provided for the monitoring of media flows and/or media properties in at least one of the flow paths or conduits. For example, in this situation it is possible, in relation to the media flows and/or media properties for the temperature, the flow speed, the pH value, the conductivity and/or the like to be measured and monitored, and, for example, also a state of “dry” or “wet.”

For very particular preference, a pump device is also provided, which is at least at times connected to the treatment head, in order to suction treatment or cleaning media or residues of filling product out of the interior of the keg. It is understood that the connection or linking of the pump device to the treatment head is configured in such a way that, in the connected state, a suctioning of media and fluids out of the interior of the keg takes place by way of the flow paths which can be connected to the interior of the keg. In this situation the pump device creates a suction effect or suction capacity by means of which a particularly rapid emptying of the keg is possible. As a result, a time-optimized emptying of the interior of the keg is made possible, at the same time with an improved degree of energy efficiency.

The treatment head and the pump device are configured and equipped in such a way that, preferably, the suctioning of medium by means of the pump device can be additionally supported by the simultaneous subjecting of the keg to compressed air, i.e. by the simultaneous blowing out of the keg based on compressed air.

The pump device can preferably be connected on the suction side to the fluid space, and, in particular, can be connected to the fluid space in a controlled manner by means of a media outlet in the region of the second media valve. The pump device can be formed by any pumps which are suitable for the conveying of fluids, such as piston pumps, eccentric pumps, vacuum pumps, or the like, and for particular preference is formed by a diaphragm pump. Means for measuring and determining a fluid level and/or the flow quantity or volume flow in the fluid space and/or in the media outlet can preferably likewise be provided, such as means for controlling the suction capacity of the pump device.

The present invention also relates to a cleaning and filling module for the internal cleaning and filling of each keg equipped with at least one keg fitting. The cleaning and filling module comprises at least one treatment head, as is described heretofore. The cleaning and filling module further comprises at least one pressing element for pressing the respective keg against the treatment head and connecting and linking devices for the connection to a media supply for the filling product and for one or more treatment or cleaning media as well as for the connection to an energy supply.

The cleaning and filling module described is in particular configured as a treatment module for the combined cleaning and filling process, and is equipped such as to allow for independent cleaning and filling operation, wherein, during the whole of the cleaning and filling process, which can also be designated as a cleaning and filling procedure, the treatment head is connected to the keg fitting of the keg which is being treated, and is mounted or coupled to the fitting with sealing effect. The cleaning and filling module described can therefore also be understood to be a combination module or multi-module. An individual or singular cleaning and filling module can therefore fulfil all the steps for the cleaning and filling of a keg, such that the cleaning and filling module described already forms the smallest unit of a treatment system. The fitting of the cleaning and filling module, namely the delivery and removal of kegs, can in this situation take place manually or with mechanical support or be carried out mechanically or even fully automatically.

The pressing element can be configured, for example, in the form of a press cross element, which is in contact with a contact section against the keg base, formed on the underside of the keg and facing upwards when the keg is in the “upside down position,” and presses down against this base with a pressure force exerted downwards from above. The pressing element can, however, also be a stop element, facing towards the underside of the keg, against which the keg is actively pressed from below with a force effect exerted from below upwards.

In particular, the cleaning and filling module described is also configured in such a way that it can be combined or coupled with further treatment modules, in particular also with further cleaning and filling modules, to form a treatment system. Due to the independence of each individual cleaning and filling module, in such a treatment system the respective cleaning and filling modules can particularly advantageously operate or be operated independently of one another. In this situation, in particular, it is also possible in each individual cleaning and filling module for the cleaning and filling processes to be matched to the respective keg which is to be treated there, and adjusted in a controlled manner depending on the particular requirement, wherein, for the adjustment of the cleaning and filling process according to the requirement, the nature or type of the keg, or a degree of dirt contamination of the keg, or the type of the filling product or the like which is to be filled, can all be taken into account.

According to a particularly preferred embodiment variant, additionally provided for at the cleaning and filling module is an outside cleaning device for cleaning the outside of kegs, such that the cleaning and filling module is configured both for external cleaning as well as for internal cleaning of the kegs and for the filling of the kegs with the filling product. In these variants, the cleaning and filling module additionally comprises a housing for the at least partial reception of the kegs, in order to retain the fluid used for the outside cleaning or the cleaning medium.

The present invention also comprises a treatment system with a plurality of cleaning and filling modules, as described heretofore, wherein at least two of the cleaning and filling modules are configured for the treatment of kegs of the same kind.

“Kegs of the same kind” is to be understood hereinafter to mean that the kegs are the same in at least one property of relevance to the cleaning and filling process and taken into consideration herein. Such properties can include the following non-conclusive enumeration of properties: Barrel volume, size, geometry, external shape, material, weight, thickness or density of the keg wall, type of keg fitting, and so on. By considering one or more of the properties it is also possible, for example, for an allocation or differentiation of different types of kegs to be carried out.

As an alternative, the treatment system described comprises a plurality of cleaning and filling modules, as described heretofore, wherein at least one first of the cleaning and filling modules is configured for the treatment of kegs of a first type, and at least one second of the cleaning and filling modules is configured for the treatment of kegs of a second type. The two types of kegs differ from one another, for example, in respect of the type of their keg fittings and/or their volume. Differences between the keg types can also relate, however, to other of the properties referred to above.

Advantageously, at least one of the cleaning and filling modules, and preferably each of the cleaning and filling modules, is in a position to interrupt a filling or cleaning process at any desired point of time of the process, and then continue with it. In particular, this allows for increased flexibility of the treatment system during the cleaning of the kegs, in particular due to the fact that, as a result of this, different effect times of a cleaning medium, in particular of an alkali, can be applied for the individual kegs.

The point of time and/or the duration of the interruption of the filling or cleaning process can be determined individually by a system operator or stored in the control unit of the treatment system. The point of time and/or the duration of the interruption can be adjusted for as long as may be desired. The adjustment of the time interruption of the cleaning or filling process in this situation does not require any structural alteration to the treatment system.

During the interruption, the keg can either remain in the cleaning and filling module or removed from the cleaning and filling module for the purpose of intermediate storage or processing, and, for example, taken to a parking place provided for this purpose. The interruption of the filling or cleaning process can also be used for another treatment, such as outside cleaning, to be carried out on the keg.

The present invention also relates to a method for the internal cleaning and filling in each case of kegs equipped with at least one keg fitting, by means of a cleaning and filling module. With the method, with the aid of a pressing element, a keg which is to be treated is brought by a placement stroke movement with its keg fitting in a sealing position with a treatment head of the cleaning and filling module and pressed against it, wherein a plunger of the treatment head is pushed along a treatment head axis in the direction of the keg fitting, and the keg fitting is opened as a result. As a result of this, at least one fluid space, formed in the treatment head, connected in a controlled manner to the flow paths or conduits communicating with the fluid space, is connected to the interior of the keg which is to be treated. The interior of the keg is then cleaned, inasmuch as at least one cleaning medium is introduced, and discharged again by way of a second controllable media valve of the treatment head serving as a return valve. During the cleaning of the interior, a first controllable media valve of the treatment head, connected to a filling product feed and serving as a product valve, and allocated to the fluid space, is held in a first closed valve position. By means of a multiple sealing arrangement of the first media valve of the treatment head, a safety or leakage space is formed, which in the first closed valve position forms a separated intermediate space between the fluid space and the filling product feed, and, as a result, reliably separates the fluid space and the filling product feed. After the cleaning of the interior with the at least one cleaning medium, the first media valve is brought in a controlled manner into a second valve-position, which takes effect as an intermediate or flushing position, as a result of which the safety or leakage space is fluidly connected to the fluid space. A head space of the treatment head, comprising the fluid space, is then flushed with at least one flushing medium. After the flushing of the head space, the first media valve is brought into a third valve position in a controlled manner, for the filling of the keg, as a result of which a filling product, in particular a beverage, is finally fed into the interior of the keg.

With the method it is advantageous if, after the cleaning of the interior with cleaning medium, the keg fitting is closed by the sliding of the plunger, and, in particular, specifically before the first media valve is moved in a controlled manner into the second valve-position, which acts as the intermediate or flushing position. The keg fitting can then preferably be opened again, after the head space of the treatment head has been flushed with the at least one flushing medium. It is understood that this step is optional and is not essential.

Advantageously, the keg remains stationary throughout the entire cleaning and filling procedure, in the same cleaning and filling module, wherein it is also integral to this that the keg fitting of the keg which is to be treated is connected throughout the entire cleaning and filling process to the treatment head of the cleaning and filling module, in particular pressed into a sealing position.

During the step of cleaning the interior of the keg, in which the first media valve of the treatment head is held in the first closed valve position, it is possible, for example, for a hot water treatment to be carried out, in which hot water is used as the cleaning medium.

For particular preference, in the closed valve position of the first media valve and before the hot water treatment, a treatment is first carried out with a further cleaning medium, in particular an alkali or acid treatment, in particular for an adjustable period of time, wherein for this purpose an alkali or acid is used as the cleaning medium. As an alternative or in addition, likewise with the closed valve position of the first media valve, after the hot water treatment a vapor treatment is carried out to dampen the interior of the keg, wherein vapor, in particular water vapor, is used as the treatment medium.

During the step of the flushing of the head space, in which the first media valve is held in the second valve-position acting as an intermediate or flushing position, it is possible, for example, for at least one hot water flushing to be carried out, wherein hot water is used as the flushing medium, and wherein, after the hot water flushing and maintaining the second valve-position of the first media valve, the blowing out of the head space is carried out, with a gas, in particular carbon dioxide, being used for this purpose as the treatment medium.

It is self-explanatory that the treatment media described only by way of example, in particular cleaning media and/or flushing media, are not restricted to the media which have been expressly mentioned. For example, cold water can also be used as a flushing medium, or water containing a disinfectant additive, such as ClO2 (chlorine dioxide), in a suitable concentration.

After the flushing of the head space and before the filling of the interior of the keg with filling product, an additional step can be optionally carried out by the preloading of the interior of the keg, and for this purpose the introduction of a preloading gas, in particular carbon dioxide into the interior. For the preloading of the interior, the keg fitting is opened by the displacing of the plunger, and, during the preloading, the first media valve is preferably held in the second valve-position.

The treatment head used with the method is preferably a treatment head such as has been described heretofore. The cleaning and filling module used with the method is preferably likewise a cleaning and filling module such as has been described heretofore.

The expression “essentially” or “approximately” signifies in the meaning of the invention deviations from the exact value in each case by ±10%, preferably by up to ±5%, and/or deviations in the form of changes which are not of significance for the function.

Further embodiments, advantages, and possible applications of the invention are also derived from the following description of exemplary embodiments and from the Figures. In this situation all the features described and/or represented in the Figures are, taken alone or in any desired combination, in principle the object of the invention, regardless of their relationship in the claims or reference to them. The contents of the claims are also deemed to be constituent parts of the description.

The invention is explained in greater detail hereinafter on the basis of the Figures in relation to exemplary embodiments. The figures show:

### BRIEF DESCRIPTION OF THE FIGURES

FIG. 1 is a schematic representation of a treatment head of an exemplary embodiment variant with a likewise partially represented keg,

FIG. 2 is a schematic representation of a section of the treatment head shown by way of example in FIG. 1 in the region of the first media valve,

FIG. 3 is a simplified sketch of the product valve in different valve positions in a partially sectional representation, and

FIG. 4 is a simplified sketch of an embodiment of a cleaning-and-filling module.

Identical reference numbers are used in the Figures for elements of the invention which are the same or have the same effect. Moreover, for the sake of easier overview, only reference figures are represented in the individual Figures which are required for the description of the respective Figure. The invention is also represented in the Figures only as a schematic view for explaining the mode of operation. In particular, the representations in the figures serve only to explain the underlying principle of the invention. For reasons of easier overview, the showing of all the component parts of the device has been avoided.

### DETAILED DESCRIPTION

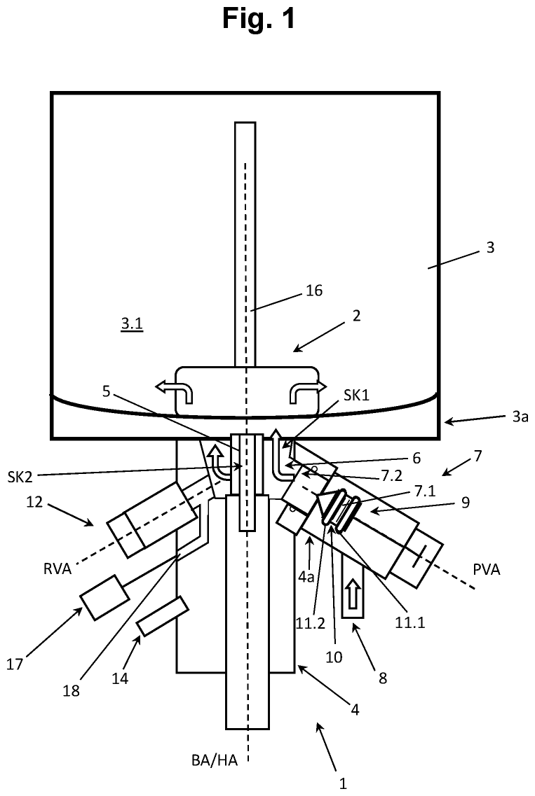

FIG. 1 shows a treatment head 1 that cleans an interior 3.1 of a keg 3 1 and fills it with a fluid filling product, such as a beverage. The treatment head 1 is thus a combined cleaning-and-filling head 1 that is assigned to a cleaning-and-filling module 20, a number of which are present in a treatment machine or treatment system.

The keg 3 has an upper side 3a or “face side.” The keg's main axis HA intersects the upper side 3a in the region of the keg's fitting 2.

The keg's fitting 2 forms first and second openings, both of which are coaxial with the keg's main axis HA.

The keg fitting's first opening connects to a rising tube 16 that extends into the keg's interior 3.1 in sections over a specific length along the main axis HA. The rising tube 16 is preferably coaxial relative to the main axis HA and opens at an end thereof that faces a base on the keg's underside. The second opening is a ring-shaped opening that surrounds the first opening and the rising tube 16, both of which are concentric with the second opening. The keg's fitting 2 includes a keg valve that closes both the first and second openings. A pressure spring biases the keg valve, thus making it a self-closing valve that can be opened for cleaning and/or filling the keg 3.

During treatment, the keg 3 is upside-down on the treatment head 1 with its fitting 2 facing downward so that it forms a seal against the treatment head 1. When the keg 3 is ready for treatment, its main axis HA and the treatment head's treatment axis BA are aligned.

The treatment head 1 comprises a treatment-head housing 4 that forms a column having a cavity in an interior thereof. The cavity accommodates a fluid space 6 and first and second flow paths SK1, SK2 that communicate with the fluid space 6 in a controlled manner. With the keg's fitting 2 opened and the keg 3 arranged in a sealing position on the treatment head 1, the first and second flow paths SK1, SK2 connect in a controlled manner with the keg's interior 3.1.

The housing's cavity at least partially accommodates a plunger 5. This plunger 5 is displaceable along the treatment-head axis BA in an axial direction. An upward axial displacement of the plunger 5 towards the keg 3 opens the keg fitting 2. Moving the plunger 5 back down allows the keg fitting 2 to close. In FIG. 1, the plunger 5 is represented in its withdrawn position so that the keg's fitting 2 remains closed.

The first and second flow paths SK1, SK2 can be brought into controlled fluid communication with the keg's interior through the fluid space 6. The first flow path SK1 fills the keg 3 with the beverage. The second flow path SK2 fills the keg with treatment media and also drains the treatment media from the keg 3. In some embodiments, the second flow path SK2 extends at least part of the way through the plunger 5.

FIG. 1 shows a product valve 7 and a return valve 12. The product valve 7 connects to a product feed 8 for controlled feeding of the beverage into the keg's interior 3.1. Although the filling product is described herein as a beverage, the principles of the invention are agnostic to the nature of the filling product.

As is further shown in FIG. 1, a media outlet 18 in the region of the return valve 12 connects to a pump 17. This pump 17 rapidly and efficiently empties the keg 3 before the beginning of the actual treatment steps as well as between treatment steps. In the example shown in FIG. 1, the pump 17 is formed by a diaphragm pump. With an appropriately produced connection of the flow paths SK1, SK2, to the keg's interior 3.1, the pump 17 creates a negative pressure that sucks fluids out of the keg's interior 3.1 and through the media outlet 18. These fluids include residues of beverage or treatment media that were used for cleaning the keg 3.

The product valve 7 extends along a product-valve axis PVA. Similarly, the return valve 12 along a return-valve axis RVA. In the example represented, the product valve 7 and the return valve 12 are arranged obliquely relative to the treatment head 1. As a result, the product-valve axis PVA and the return-valve axis RVA form an acute or essentially acute angle relative to the treatment-head axis BA. The relative arrangement of the product valve 7 and the return valve 12 means that they do not lie opposite one another in relation to the treatment head axis BA. Rather, the product-valve axis PVA and the return-valve axis RVA enclose with one another an angle of about thirty degrees.

The product valve 7 and the return valve 12 connect to a valve-housing section 4a that serves as the treatment-head housing's transition section or valve-transition section. In some embodiments, the valve-housing section 4a is an integral part of the treatment-head housing 4 so that the valve-housing section 4a and the treatment-head housing 4 form a unitary structure.

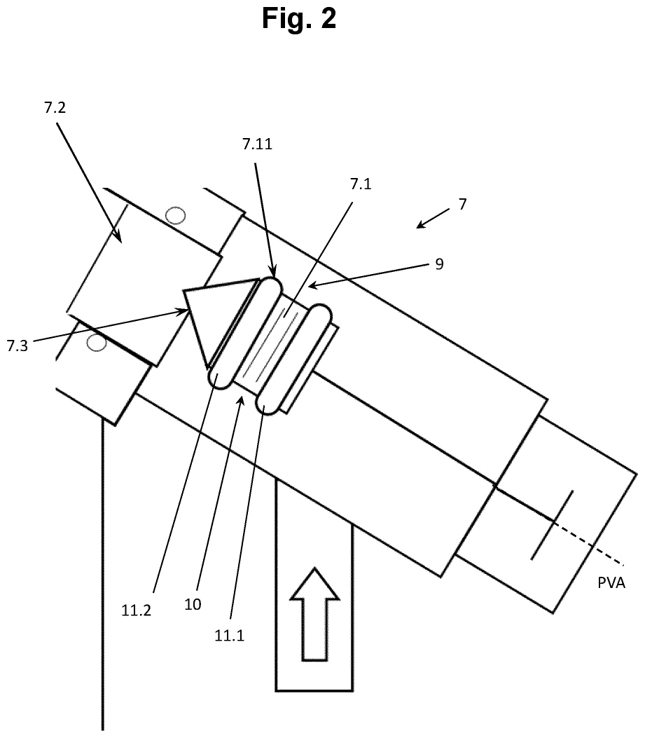

As shown in FIG. 2, the product valve 7 has a valve body 7.1 that moves along the product-valve axis PVA in response to an actuator (not shown). The valve body 7.1 is thus an actuator plunger.

As can be seen in FIG. 1, the valve body 7.1 has a sealing surface 7.11 that at least partially projects into a valve-housing section 4a. The product valve 7 also includes a projection 7.3 that projects distally past the sealing surface 7.11.

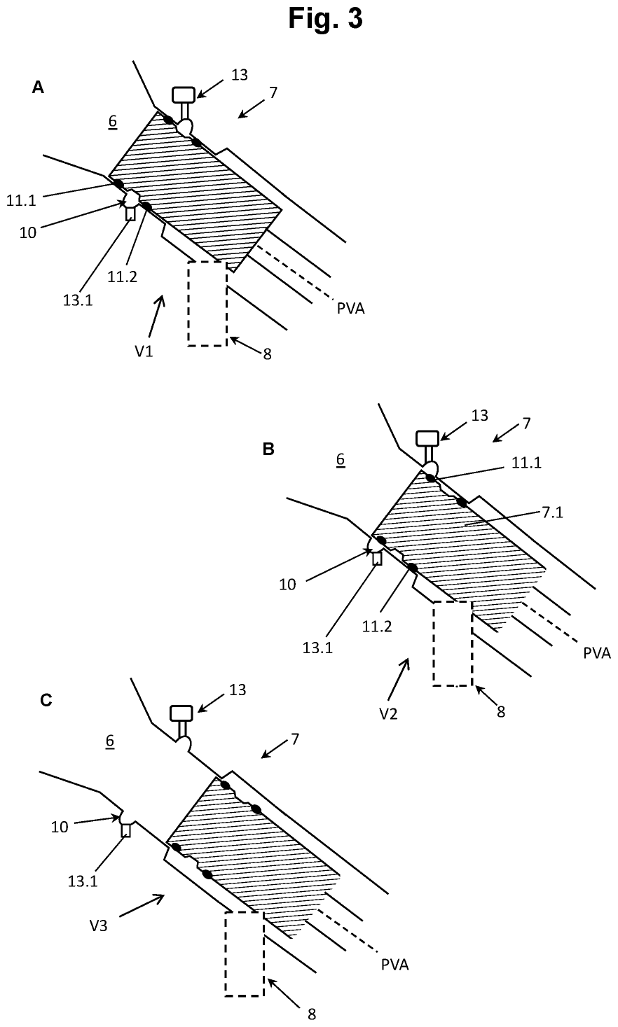

FIG. 3 shows three positions of the product valve 7: a closed position V1, an intermediate, or flushing position V2, and an open position or filling position V3.

In its closed position V1, the valve body 7.1, and in particular, its sealing surface 7.11, forms a seal against a valve seat 7.2 in the valve-housing section 4a, as shown in in FIG. 3. The projection 7.3, which projects past the sealing surface 7.11, thus extends into the fluid space 6. This reduces dead space.

In its filling position V3, which is shown in both FIG. 1 and FIG. 3, the valve body 7.1 is located at a distance from the valve seat 7.2. This creates the first flow path SK1 for moving beverage from the product feed 8 into the fluid space 6.

The treatment head 1 includes a controller, not shown, that controls and monitors both the product valve 7 and the return valve 12. The controller controls and monitors the valve positions and the switching of the product valve 7 and the return valve 12. A sensor 14 at the treatment head 1 provides data indicative of media flow and media properties in the first and second flow paths SK1, SK2. The sensor 14 provides this data to the controller, which then takes it into account when controlling the movement of the product valve 7 and the return valve 12.

The treatment head 1 is multifunctional. It is used for both treating and filling the keg. During a switchover from treating (or cleaning) to filling, it is important to ensure that treatment medium does not mix with the beverage and vice versa. To promote reliable separation between beverage and treatment media, the product valve 7 includes a multiple sealing arrangement 9 for multiple sealing of the product feed 8 against the fluid space 6. This makes it essentially impossible to have contaminating residue of either substance in the fluid space 6 and/or the dead space or in a head space in front of the front end of the valve body 7.1.

The treatment head's multiple sealing arrangement 9 forms a safety-or-leakage space 10. In the product valve's closed position V1, this safety-or-leakage space 10 forms a separated intermediate space between the fluid space 6 and the product feed 8 that reliably separates the product feed 8 and the fluid space 6 from each other. Through appropriately controlled switching of the product valve 7 and the return valve 12, it is possible to flush the safety-or-leakage space 10 between cleaning and filling the keg 3.

Referring to FIG. 3, a controlled outlet 13.a and a flushing device 13 cooperate in flushing out the safety-or-leakage space 10. In this case, opening the controlled outlet 13.1 allows media to escape when flushing out the safety-or-leakage space 10.

In the illustrated embodiment, the multiple sealing arrangement 9 comprises a double-seat valve having a first sealing element 11.1 and a second sealing element 11.2, both of which that extend radially from the product-valve axis PVA. The first and second sealing elements 11.1, 11.2 are arranged along the valve body 7.1 and displaced along the product-valve axis PVA relative each other by some distance. A ring groove, or indentation, lies between the first and second sealing elements 11.1, 11.2. In the product valve's closed position V1, the interaction of the sealing elements 11.1, 11.2 and the valve-housing section 4a on an inner side thereof results in the fluid space 6 being doubly sealed in relation to the filling product feed 8 via the tightly-closed safety-or-leakage space 10.

In the closed position V1, the ring groove is directed towards a cut-out opening in the valve-housing section 4a. In a preferred embodiments, this opening is a ring shaped opening at the same axial position. In the flushing position V2, the valve body 7.1 is displaced along the product-valve axis PVA in such a way that the safety-or-leakage space 10 is opened towards the fluid space 6 to form a fluid connection therebetween. However, the second sealing element 11.2 causes it to remain sealed in relation to the filling production feed 8.

In this flushing position V2, it becomes possible to reliably flush the safety-or-leakage space 10 in such a way that the fluid space 6 and a head space in front of the valve body 7.1 are reliably flushed and/or blown out together with the safety or safety-or-leakage space 10.

In the filling position V3, the valve body 7.1 is displaced still further along the product-valve axis PVA. As a result, the fluid space 6 and the filling product feed 8 are now in fluid communication with each other. This forms an open ring conduit through which filling product flows from the filling product feed 8 into the fluid space 6.

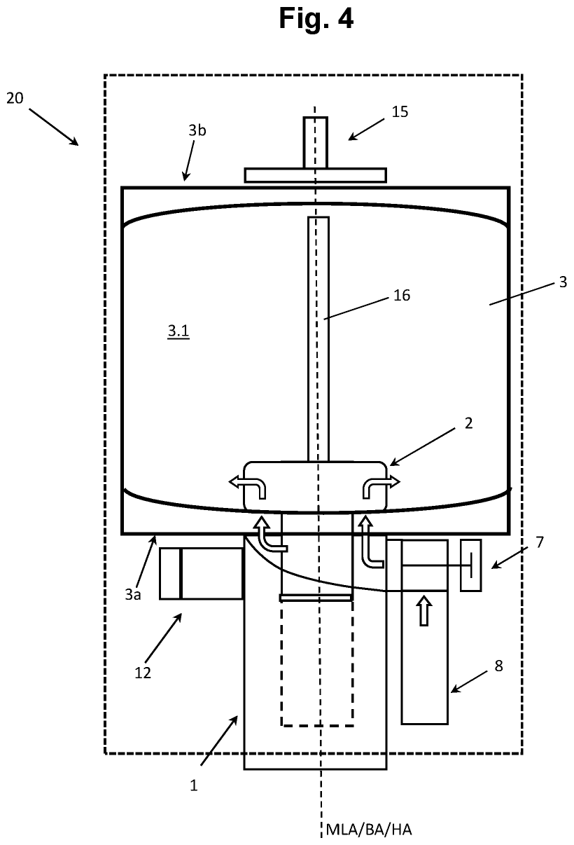

FIG. 4 shows steps in the use of the multifunctional treatment head 1 for cleaning and filling a keg 3 at a cleaning-and-filling module 20.

The process begins with an empty keg 3 being introduced into the cleaning-and-filling module 20 and positioned on the treatment head 1. A press 15 executes a placement stroke to seal the fitting 2 against the treatment head 1. A sealing test monitors this sealing operation. The plunger 5 then moves to open the keg's fitting 2 in preparation of a cleaning process.

The internal cleaning includes sequential cleaning steps, each of which includes feeding a certain quantity of treatment medium and allowing it to remain for a predetermined time interval. Following the predetermined time interval, opening the return valve 12 allows the treatment medium to be conveyed onward. The return valve 12 is thus controlled and/or regulated so that it opens and closes at the correct times at each cleaning step. In some cases, the correct times are adaptively determined based on data from the sensor 14. While cleaning the keg's interior 3.1, the product valve 7 remains in its closed position V1.

A useful initial treatment step is one in which the first treatment medium is alkaline or acidic. This initial treatment step extends for an adjustable time interval, with the time interval being adjustable based either on data from the sensor 14 or on programmed instructions.

Following the initial treatment step, with the product valve 7 remaining in its closed position V1, the cleaning process continues with introduction of hot-water or cold-water treatment and hot-water or cold-water flushing. Some cleaning processes include a vapor treatment in which a vapor, such as water vapor, serves as the treatment medium to dampen the keg's interior 3.1. Throughout these steps, the product valve 7 remains in its closed position V1.

In the product valve's closed position V1, the fluid space 6 and the filling product feed 8 remain securely separated from one another and double sealed from one another by way of the multiple sealing arrangement 9, and in particular the safety-or-leakage space 10 formed above it.

Upon completion of the cleaning steps, the product valve 7 moves into the flushing position V2 to carry out a head or dead-space flushing and to flush the safety-or-leakage space 10. In some practices, the keg's fitting 2 remains open during this process. In others, the plunger 5 closes it. In such cases, the plunger 5 moves before, during, or after switching the product valve 7 into the flushing position V2.

The flushing of the head space, which comprises the fluid chamber 6 and/or the safety-or-leakage space 10, is carried out, for example, with water, which is either hot water or cold water. After the water-flushing step, the product valve 7 remains in its flushing position V2. This permits the head space to be blows out, for example with a gaseous treatment medium, such as carbon dioxide. In those cases in which the keg's fitting 2 was closed for the flushing of the head space, it is opened again after the flushing and blowing out process.

An optional step before actually filling the keg 3 is to load the keg's interior 3.1 with a preloading gas, such as carbon dioxide. During the preloading period, the product valve 7 is preferably held in its flushing position V2. After the preloading, the product valve 7 is moved in a controlled manner into its filling position V3 for filling the keg 3 with the beverage. This continues until the keg 3 has been filled to a desired level, at which point the product valve 7 closes.

At the end of the filling step, the plunger 5 moves to close the keg's fitting 2. The head space is then flushed with hot water and blown out. The seal between the keg's fitting 2 and the treatment head 1 is then broken, thereby decoupling the fitting 2 from the treatment head 1. The now-filled keg 3 is then removed from the cleaning-and-filling module 20.

The invention has been described heretofore on the basis of exemplary embodiments. It is understood that a large number of modifications or deviations are possible, without thereby departing from the scope of protection of the invention defined by the claims.

1. An apparatus for treating a keg that comprises a fitting and an interior, said apparatus comprising a treatment head, wherein said treatment head comprises a treatment head housing, a plunger, a product valve, and a return valve, wherein said plunger is held in said treatment head housing and is axially movable along a treatment head axis for opening said fitting when said keg is arranged in a sealing position at said treatment head for treatment, wherein said treatment head forms a fluid space and first and second flow paths therein for communicating in a controlled manner with said fluid space, wherein, when said fitting is open, said flow paths can be connected to said interior, wherein said product valve and said return valves are controllable, wherein said product valve is assigned to said fluid space and that is connected to a filling-product feed for controlled feeding of a beverage into said interior and that comprises a multiple sealing arrangement for said multiple sealing of said filling-product feed against said fluid space, wherein, said multiple sealing arrangement forms a safety-or-leakage space is formed that forms a separated intermediate space between said fluid space and said filling product when said product valve is in a closed position thereof.

2. The apparatus of claim 1, wherein said treatment head further comprises a flushing device at said multiple sealing arrangement, wherein said flushing device comprises a flushing valve and a controlled outlet for flushing said safety-or-leakage space.

3. The apparatus of claim 1, wherein said multiple sealing arrangement of said first media valve comprises a double-seat valve.

4. The apparatus of claim 1, wherein said first flow path fills said interior with said beverage, wherein said second flow path provides controlled flow treatment medium into and out of said interior, and wherein said second flow path extends at least partway through said plunger.

5. The apparatus of claim 1, wherein said return valve comprises a double-seat valve that forms a multiple sealing arrangement.

6. The apparatus of claim 5, wherein said product valve and said return valve are arranged relative to each other such that a product-valve axis of said product valve and a return-valve axis of said return valve enclose an angle of less than ninety degrees.

7. The apparatus of claim 1, wherein said product valve comprises a valve seat and a valve body that is movable along a product-valve axis of said product valve and that comprises a sealing surface that seals against a valve seat.

8. The apparatus of claim 7, wherein said product valve has a closed position in which said sealing surface contacts said valve seat.

9. The apparatus of claim 8, wherein movement of said valve body along said product-valve axis causes said product valve to assume a flushing position in which said fluid space is in fluid communication with said safety-or-leakage space and in which said filling-product feed is sealed from said safety-or-leakage space, which is in fluid contact with said fluid space.

10. The apparatus of claim 9, wherein further movement of said valve body along said product-valve axis causes said product valve to assume a filling position in which said fluid space is in fluid communication with said safety-or-leakage space and said filling-product feed.

11. The apparatus of claim 7, wherein said valve body comprises a projection that projects over said sealing surface along said product-valve axis and extends into said fluid space to reduce a dead space when said product valve is in said closed position and wherein said projection is configured to pivot or fold.

12. The apparatus of claim 11, wherein said projection has a shape that is asymmetric shape or free form.

13. The apparatus of claim 1, wherein, in a region of said product valve and/or said return valve, said fluid space has an oval cross section to accommodate an oval free-form seal with multiple cambering.

14. The apparatus of claim 1, wherein said product valve and said return valve are arranged obliquely at said treatment head such that a product-valve axis of said product valve and a return-valve axis of said return valve form an acute angle relative to said treatment-head axis.

15. The apparatus of claim 1, wherein said treatment-head housing comprises a guide surface for guiding and deflecting flow of said beverage into said keg and wherein said guide surface extends into said fluid space and/or delimits said fluid space.

16. The apparatus of claim 1, wherein a controller controls said product valve and said return valve.

17. The apparatus of claim 1, further comprising a sensor for monitoring fluid flue along at least one of said first and second flow paths.

18. The apparatus of claim 1, wherein said product valve comprises a double-seat valve and/or a further double-seat valve is arranged at said product feed.

19. The apparatus of claim 1, further comprising a pump that connects to said treatment head in such a way as to suck residues of beverage or treatment media out of said interior.

20. The apparatus of claim 19, wherein said pump connects to a suction side to said fluid space at a media outlet.

21. The apparatus of claim 19, wherein said pump comprises a diaphragm pump having a controllable suction capacity.

22. The apparatus of claim 1, further comprising a press that presses said keg against said treatment head.

23. The apparatus of claim 1, further comprising a cleaning-and-filling module that comprises said treatment head, said cleaning-and-filling module being configured to clean an outer surface of said keg.

24. The apparatus of claim 1, further comprising plural cleaning-and-filling modules, one of which comprises said treatment head.

25. The apparatus of claim 24, further comprising first and second cleaning-and-filling modules, wherein said first cleaning-and-filling module comprises said treatment head and wherein said first and second cleaning-and-filling modules are configured for treating kegs of first and second types, respectively, said first and second types differing in at least one of a type of keg fitting and a volume.

26. A method comprising, using, a cleaning-and-filling, module for cleaning, and filling a keg, that comprises a fitting and an interior, said method comprising causing a pressing, element to execute a placement stroke movement to said keg into a sealing position with a treatment head of said cleaning-and-filling module, moving a plunger along a treatment-head axis towards said keg to open said fitting, thereby forming a fluid space in said treatment head and forming fluid paths that communicate in a controlled manner with said fluid space and that are connected to said interior, holding a product valve in a closed position, thereby causing a multiple sealing arrangement of said product valve to form a safety-or-leakage space that functions as a separate intermediate space between said fluid space and a product feed, thereby reliably separating said fluid space and said product feed, cleaning said interior with a cleaning module, moving said product valve into a flushing position to cause fluid communication between said safety-or-leakage space and said fluid space and to allow a head space of said treatment head, which comprises said fluid space, to be flushed with a flushing medium, and moving said product valve into a filling position to fill said keg with a beverage.

27. The method of claim 26, wherein using a cleaning-and-filling module for cleaning and filling a keg comprises causing said keg remains stationary in said cleaning-and-filling module throughout cleaning and filling of said keg and causing said fitting to remain sealed against said treatment head throughout said cleaning and filling of said keg.

28. The method of claim 26, wherein cleaning said interior comprises, while said product valve is in said closed position, carrying out hot-water treatment in which hot water is used as said cleaning medium.

29. The method of claim 28, wherein cleaning said interior comprises carrying out at least one of a first cleaning step and a second cleaning step while said product valve is in said closed position, wherein said first cleaning step comprises treating said interior with an alkaline solution for an adjustable period of time and wherein said second cleaning step comprises carrying out a vapor treatment for damping said interior, said vapor being water vapor.

30. The method of claim 26, further comprising flushing said head space, wherein flushing said head space comprises at least one of using hot water as a flushing medium and, with said product valve still in said flushing position, using a gas to blow out said head space.

31. The method of claim 26, further comprising flushing said head space and, after having flushed said head space and before filling said keg, pretensioning said interior with a pretensioning gas, wherein pretensioning said interior comprises moving said plunger to open said fitting and holding said product valve in said flushing position.

32. (canceled)
